(19) United States
(12) Patent Application Publication
(10) Pub. No.: US 2010/0096601 A1
(43) Pub. Date: Apr. 22, 2010

(54) Molecules with complexing groups for aqueous nanoparticle dispersions and uses thereof

(76) Inventor: Frank Vito DiStefano, Macungie, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/583,439

(22) Filed: Oct. 19, 2006

Related U.S. Application Data
(60) Provisional application No. 60/797,251, filed on May 2, 2006.
(60) Provisional application No. 60/730,735, filed on Oct. 27, 2005.

(51) Int. Cl. H01B 3/20; B01F 3/12; B01F 17/00

(52) U.S. Cl. 252/572; 516/31; 516/33; 516/34

(57) ABSTRACT

Stable dispersions of nanoparticles and microparticles in liquids and method for their preparation are disclosed. The dispersions can comprise about 0.1 wt % to about 25 wt % of at least one disodium salt monohydrate of 4-5-dihydroxy-1,3 benzenedisulfonic acid; about 1 wt % to about 90 wt % of particles; and about 10 wt % to about 90 wt % of at least one liquid. The particles can comprise nanoparticulate metals, metal oxides, silica and coated particles. The liquid can comprise at least one polar liquid.

This Application claims the benefit of Provisional Application No. 60/730,735, filed on Oct. 27, 2005 and Provisional Application No. 60/797,251, filed on May 2, 2006. The disclosure of these Provisional Applications is hereby incorporated by reference.

### CROSS-REFERENCE TO RELATED APPLICATIONS

The subject matter herein is related to U.S. patent application Ser. No. 11/524,471, filed on Sep. 21, 2006 and entitled “Use Of 2,3-Dihydroxynapthalene-6-Sulfonic Acid Salt As A Dispersant”; the disclosure of which is hereby incorporated by reference.

### BACKGROUND OF THE INVENTION

The invention relates to dispersions. In particular, the invention relates to stable dispersions of nanoparticles and microparticles in liquids and to methods for their preparation.

Nanoparticles of Group IIIA metal oxides, specifically, those of aluminum and indium have important commercial applications. Nano alumina is of interest for scratch resistant coatings and heat transfer fluids. Additionally, aluminum metal nanoparticles that have been passivated with a thin layer of aluminum oxide are of use in the development of energetic materials. Indium tin oxide (ITO) nanoparticles have applications in clear conductive coatings, in heat management layers, and in static charge dissipation. Zinc oxide and titanium oxide nanoparticles have applications in UV blocking sunscreens, coatings and textiles. Other applications of metal oxide nanoparticles and/or nanoparticles that have a metal oxide surface include magnetic materials, heterogeneous catalysts, toner compositions, and ceramics.

In order to supply nanoparticles and/or microparticles as easy to use dispersion master batches or in fully formulated compositions, the particles must be dispersed in various liquids and polymeric matrices. The quality of the dispersion must support its intended use. For example, the presence of color and opacity or haze are is unacceptable in many applications, including inks and coatings. In addition, the dispersion is preferably stable so it does not have to be prepared immediately before use, but can be stored after preparation.

Currently, many nanoparticle dispersions are prepared by functionalizing the surface of the particles with materials such as silanes. This approach uses expensive silanes and requires additional processing steps. Alternatively, ionic dispersants that rely upon electrostatic attraction for anchoring to the particle surface are used. Below the isoelectric point, where the nanoparticle is inherently cationic, an anionic dispersant is required to achieve surface anchorage. Above the isoelectric point, where the particle is inherently anionic, a cationic dispersant is required. Consequently, the resulting dispersion can not tolerate a wide pH range. In addition, many materials used in coatings, inks, are anionic and not compatible with cationic materials. Thus, a need exists for stable dispersions of nanoparticles and/or microparticles particles of metal oxides and/or particles that have an metal oxide surface that do not have these problems, and to methods for preparing these dispersions.

### BRIEF SUMMARY OF THE INVENTION

The instant invention solves problems associated with conventional practices by providing a composition comprising a dispersion of particles in at least one liquid (e.g., at least one polar liquid).

In one aspect, the composition comprises:
a) about 0.1 wt % to about 25 wt %, based on the total weight of the dispersion, of at least one dispersant comprising the formula:

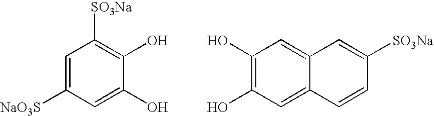

b) about 1 wt % to about 90 wt %, based on the total weight of the dispersion, of particles comprising at least one member selected from the group consisting of metal oxide particles, particles having a metal oxide surface, and mixtures thereof, in which the particles have a particle size of about 1 nm to about 2000 nm; and
c) about 10 wt % to about 90 wt %, based on the total weight of the dispersion, comprising at least one member selected from the group consisting of water, ethylene glycol, propylene glycol, glycerin, glycol mono-ethers of the formula R″OCH₂CH₂OH, in which R″ is an alkyl group of one to four carbon atoms, and mixtures thereof.

In another aspect of the invention, the composition comprises:
a) about 10 wt. % to about 90 wt. % water,
b) about 0.1 wt % to about 25 wt %, based on the total weight of the dispersion, of at least one dispersant selected from the group consisting of ortho-dihydroxyaromatic sulfonic acid salts (e.g., having the previously identified formula), and optionally at least one of the following: polyoxyethylenated long-cain amines, polyoxyethylenated alkyphenols, polyoxyethylenated alcohols, polyoxyethylenated carboxylic acids, polyoxyethylenated sorbitol esters, polyoxyethylenated alkanolamides, long-chain carboxylic acid esters, poly(ethylene oxide-co-propylene oxide) and sulfonated, sulfated, phosphated or phosphonated derivatives of the above; the class of materials known as polymeric dispersing agents which comprise certain polyacrylates, polyesters, polyamides, maleic acid/vinyl polyether copolymer, styrene-maleic acid copolymers, polyurethanes, polyimides, polyethers, polysilicones, as well as amine, alcohol, acid, ester and other functionalized derivatives of the previous list and copolymers of the same, among others,
c) about 1 wt % to about 90 wt %, based on the total weight of the dispersion, of particles comprising at least one member selected from the group consisting of metal oxide particles, particles having a metal oxide surface, and mixtures thereof, in which the particles have a particle size of about 1 nm to about 2000 nm;
d) optionally about 10 wt % to about 90 wt %, based on the total weight of the dispersion, comprising at least one member selected from the group consisting of water, ethylene glycol, propylene glycol, glycerin, glycol mono-ethers of the formula R″OCH₂CH₂OH, in which R″ is an alkyl group of one to four carbon atoms, and mixtures thereof,
e) optionally about 1 wt % to about 99 wt %, based upon the total weight of the dispersion, comprising at least one member selected from the group consisting of water-borne polymers such as emulsion polymers, aqueous polymer dispersions, aqueous polymer colloids, and aqueous polymer solutions. These water-borne polymers may comprise at least one of urethane, acrylic, styrene-acrylic, siloxane, vinyl acetate, vinyl chloride and among other polymers; and;
f) optionally all or part of the metal oxide nanoparticles can be replaced with about 10 wt % to about 90 wt %, based on the total weight of the dispersion, comprising at least one member selected from the group of metal nanoparticles.

In a further aspect of the invention, the dispersing agent comprises a compound having the formula:

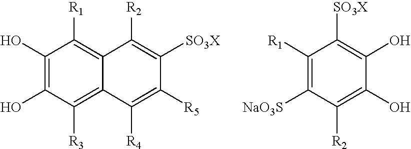

wherein R1-R4 comprise H and/or alkyl, and X comprises at least one member selected from the group consisting of Na, K, Li, NH4, R1NH2, R2NH, and R3N

These compositions find utility as binders, coatings, inks, and surface treatments in the textile, coatings, graphic arts, and personal care industries.

In one aspect, the particles are nanoparticles, having an average diameter of about 1 nm to about 100 nm. In another aspect, the invention comprises a method for preparing the dispersion by dispersing the particles in a liquid medium comprising at least one dispersant.

### DETAILED DESCRIPTION OF THE INVENTION

Unless the context indicates otherwise, in the specification and claims, the terms particles, metal oxide particles, particles having a metal oxide surface, dispersant, liquid, cation, and similar terms also include mixtures of such materials. Unless otherwise specified, all percentages are percentages by weight and all temperatures are in degrees Centigrade (degrees Celsius).

In one aspect the invention comprises a dispersion of particles having a particle size of about 1 nm to about 2000 nm in liquid. The particles comprise at least one member selected from the group consisting of metal oxide particles, particles having a metal oxide surface, and mixtures thereof. The dispersion comprises the dispersant, the particles, and at least one liquid.

In one aspect of the invention, the dispersant comprises at least one orthodihydroxyaromatic sulfonic acid salt such as disodium salt monohydrate of 4-5-dihydroxy-1,3 benzenedisulfonic acid typically having the following formula:

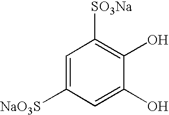

or sodium 2,3-dihydroxy-6-naphthalene sulfonate typically having the following formula:

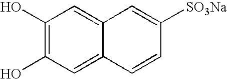

Disodium salt monohydrate of 4-5-dihydroxy-1,3 benzenedisulfonic acid is commercially available from Merck AG under the trade name “Tiron”. Sodium 2,3-dihydroxy-6-naphthalene sulfonate is available as a dye precursor sold under the name dihydroxy R salt Nantog Baisheng Chemicals Co. By using an effective amount of the inventive dispersant, a composition can be obtained having a viscosity of less than about 2000 centipoises (e.g., less than about 1000 centipoises).

In another aspect of the invention, the composition comprises:
a) about 10 wt. % to about 90 wt. % water,
b) about 0.1 wt % to about 25 wt %, based on the total weight of the dispersion, of at least one dispersant selected from the group consisting of orthodihydroxyaromatic sulfonic acid salts (e.g., having the previously identified formula), and optionally at least one of the following: polyoxyethylenated long-cain amines, polyoxyethylenated alkyphenols, polyoxyethylenated alcohols, polyoxyethylenated carboxylic acids, polyoxyethylenated sorbitol esters, polyoxyethylenated alkanolamides, long-chain carboxylic acid esters, polyethylene oxide-co-propylene oxide), and sulfonated, sulfated, phosphated or phosphonated derivatives of the above; the class of materials known as polymeric dispersing agents which comprise certain polyacrylates, polyesters, polyamides, maleic acid/vinyl polyether copolymer, styrene-maleic acid copolymers, polyurethanes, polyimides, polyethers, polysilicones, as well as amine, alcohol, acid, ester and other functionalized derivatives of the previous list and copolymers of the same, among others,
c) about 1 wt % to about 90 wt %, based on the total weight of the dispersion, of particles comprising at least one member selected from the group consisting of metal oxide particles, particles having a metal oxide surface, and mixtures thereof, in which the particles have a particle size of about 1 nm to about 2000 nm;
d) optionally about 10 wt % to about 90 wt %, based on the total weight of the dispersion, comprising at least one member selected from the group consisting of water, ethylene glycol, propylene glycol, glycerin, glycol mono-ethers of the formula R″OCH₂CH₂OH, in which R″ is an alkyl group of one to four carbon atoms, and mixtures thereof,
e) optionally about 1 wt % to about 99 wt %, based upon the total weight of the dispersion, comprising at least one member selected from the group consisting of water-borne polymers such as emulsion polymers, aqueous polymer dispersions, aqueous polymer colloids, and aqueous polymer solutions. These water-borne polymers may comprise at least one of urethane, acrylic, styrene-acrylic, siloxane, vinyl acetate, vinyl chloride and among other polymers; and;
f) optionally all or part of the metal oxide nanoparticles can be replaced with about 10 wt % to about 90 wt %, based on the total weight of the dispersion, comprising at least one member selected from the group of metal nanoparticles.

In a further aspect of the invention, the dispersant comprises a medium comprising water, one dispersant selected from the group consisting of orthodihydroxyaromatic sulfonic acid salts (e.g., having the previously identified formula), and optionally at least one of the group consisting of polyoxyethylenated long-cain amines, polyoxyethylenated alkyphenols, polyoxyethylenated alcohols, polyoxyethylenated carboxylic acids, polyoxyethylenated sorbitol esters, polyoxyethylenated alkanolamides, long-chain carboxylic acid esters, poly(ethylene oxide-co-propylene oxide), and sulfonated, sulfated, phosphated or phosphonated derivatives of the above; polymeric dispersing agents which comprise at least one member from the group of polyacrylates, polyesters, polyamides, maleic acid/vinyl polyether copolymer, styrene-maleic acid copolymers, polyurethanes, polyimides, polyethers, polysilicones, as well as amine, alcohol, acid, ester and other functionalized derivatives of the previous list and copolymers of the same, among others.

In another aspect, at least one the inventive dispersion can further comprise at least one latex compound such as latexes derived from the following monomers used either alone or in combination: acrylate esters, acrylic acid, methacrylate esters, methacrylic acid, acrylonitrile, ethylene, styrene, butadiene, vinyl chloride, vinyl acetate. For example, the inventive composition can comprise nanoparticles, at least one orthodihydroxyaromatic sulfonic acid salt, at least one latex and at least one non-ionic copolymer with carboxy anchor groups, pH=7 (e.g., Disperbyk-190).

Desirable results have been obtained by using a dispersant comprising a medium comprising water, an orthodihydroxyaromatic sulfonic acid salt, and at least one of the foregoing optional components. By using an effective amount of such dispersant(s) a composition can produced having electrostatic and steric stabilization.

The dispersion comprises microparticles and/or nanoparticles. Nanoparticles generally refers to particles that have an average diameter of about 100 nm or less, typically between about 100 nm and about 1 nm. Nanoparticles have an intermediate size between individual atoms and macroscopic bulk solids. Because of their relatively small size, the physical and chemical properties of nanoparticles, especially those of nanoparticles smaller than about 50 nm, may differ measurably from those of the bulk material. Microparticles are larger than nanoparticles. They have an average diameter of about 100 nm (0.1 micron) to about 100 microns. The dispersion typically comprises particles that have an average diameter of about 2000 nm or less, typically an average diameter of about 1 nm to about 2000 nm. Typically greater than about 50% of the particles are less than 100 nm and normally greater than about 90% of the particles are less than 100 nm (e.g., 95% of the particles are less than 100 nm).

Particle size refers to the size of the particles determined by the BET (Brunauer, Emmet, Teller) method. This method, which involves adsorbing a monolayer of liquid nitrogen onto the surface of a mass of particles, then measuring the amount of nitrogen released when that monolayer is vaporized, is well known to those skilled in the art. The particle size measured for the particles in the dispersion, which is measured by other methods, may be larger than the particle size determined by the BET method because of aggregation of the primary nanoparticles into aggregates. As discussed below, the particle size measured for the particles in the dispersion is a measure of the ability of the dispersing agent to produce a dispersion.

The particles comprise at least one member selected from the group consisting of metal oxide particles, particles having a metal oxide surface, and mixtures thereof. Although the metal oxide particles may be particles of any metal oxide that forms the dispersion, typical metal oxides comprise at least one member selected from the group consisting of alumina (Al₂O₃), indium tin oxide (a mixture comprising In₂O₃ and SnO₂), zirconia (ZrO₂), titania (TiO₂), iron oxide (Fe₂O₃), ceria (CeO₂), zinc oxide (ZnO), and mixtures thereof. More typically, the metal oxide comprises alumina or indium tin oxide. The metal oxide particles may be doped with other materials. Typical particles having a metal oxide surface include aluminum metal particles with a surface layer of aluminum oxide.

The liquid may be any liquid (e.g., a polar liquid) in which the dispersion may be formed. Typical liquids comprise at least one member selected from the group consisting of water, ethylene glycol, glycerin, propylene glycol, ethylene glycol mono-ethers, and mixtures thereof. Typical ethylene glycol mono-ethers are compounds of the structure R″OCH₂CH₂OH, in which R″ comprises an alkyl group of one to four carbon atoms, such as methyl, ethyl, n-propyl, or n-butyl. Common ethylene glycol mono-ethers include 2-methoxyethanol (methyl CELLOSOLVE®) and 2-butoxyethanol (butyl CELLOSOLVE®). In some cases, the composition is substantially free of water or the composition is prepared (e.g., as a “master batch”), and then added to water. By substantially free of water it is meant the composition contains less than about 1 wt. % water.

Typically, the dispersion comprises about 0.1 wt % to about 25 wt % of the dispersant, about 1 wt % to about 90 wt % of the particles, and about 10 wt % to about 90 wt % of the liquid, based on the total weight of the dispersion. More typically the dispersion comprises about 0.1 wt % to about 10 wt % of the dispersant, about 5 wt % to about 80 wt % of the particles, and about 5 wt % to about 80 wt % of the liquid, based on the total weight of the dispersion. Most typically the dispersion comprises about 0.1 wt % to about 5 wt % of the dispersant, about 10 wt % to about 70 wt % of the particles, and about 25 wt % to about 75 wt % of the liquid, based on the total weight of the dispersion. Typically, the dispersant, the particles, and the liquid together make up at least about 95 wt %, more typically at least about 98 wt % up to about 100 wt %, of the dispersion. The dispersion may consists essentially of the particles, the dispersant, and the liquid, or the dispersion may comprise other ingredients that are commonly used in dispersions used in the inks, coatings, and/or adhesives, such as, for example, other dispersants; surfactants, such as, for example, nonionic and anionic surfactants; defoamers; and wetting agents.

In one aspect of the invention, the dispersant further comprises the sodium salt (R═Na⁺), 2,3-dihydroxynaphthalene-6-sulfonic acid sodium salt. The sodium salt is commercially available from Nantog Baisheng Chemicals Co. under the trade name “Dihydroxy R Salt” or “DHR”.

Surfactants may be present at levels of about 0.1 to about 10.0 wt % of the dispersion. Nonionic surfactants are well know to those skilled in the art and can comprise at least one ethoxylates of alkyl phenols containing from about 8 to about 18 carbon atoms in a straight-or branched chain alkyl group, such as t-octyl phenol and t-nonyl phenol with about 5 to about 30 moles of ethylene oxide; and ethoxylates of primary alcohols containing about 8 to about 18 carbon atoms in a straight or branched chain configuration with about 5 to about 30 moles of ethylene oxide, for example, lauryl or myristyl alcohol condensed with about 16 moles of ethylene oxide. Anionic surfactants are well known to those skilled in the art. Anionic surfactants are salts, especially water soluble salts in which the cation comprise at least one of sodium, potassium, ammonium, or substituted ammonium, such as the cations of ethanol amine, diethanol amine, and triethanol amine salts and in which the surfactant portion is negatively charged. These surfactants can comprise at least one C₈-C₂₂ alkyl sulfates, alkyl sulfonates, alkyl sulfosuccinates, and alkylbenzene sulfonates, such as linear alkylbenzene sulfates and sulfonates; sulfates of ethoxylated C₈-C₂₂ alkyl alcohols in which the alkyl group contains about 10 to about 22 and the polyoxyethylene chain contains about 0.5 to about 22 moles of ethylene oxide alkyl alcohol; and phosphates of alkyl alcohols, ethoxylated alkyl alcohols, and ethoxylated alkyl phenols.

Defoamers may be present at levels of about 0.01 to about 3.0 wt % of the dispersion. Defoamers can comprise at least one of silicones such as polyether modified dimethylsiloxanes, for example BYK 307 and BYK 333 (Byk Chemie, Wallingford, Conn., USA), and acetylinic diols such as those sold under the SURFYNOL® trademark (Air Products and Chemicals, Allentown, Pa., USA). Wetting agents may be present at levels of about 0.1 to about 10.0 wt %. Wetting agents can comprise at least one of sodium dioctylsulfosuccinate and acetylinic diols such as those sold under the DYNOL® trademark (Air Products and Chemicals, Allentown, Pa., USA).

The particles can form a stable dispersion in the liquid. That is, the resulting dispersion does not exhibit separation of components, a dramatic increase in viscosity, and/or flocculation of the particles within 24 hours. Typically, the dispersion is stable for at least seven days. This allows master batches to be prepared and stored until needed.

In another aspect, the invention comprises a method for preparing the stable dispersion. The method comprises dispersing the particles in the liquid containing the dispersant. The dispersant is dissolved in the polar liquid and the pH adjusted, if necessary. For example, if the dispersion is ultimately to be used in a formulation that is typically in the range of pH about 8 to about 9, such as many inks or coatings, the dispersant solution can be adjusted to this pH range by addition of about 10% aqueous sodium hydroxide or an amine such as AMP-95 (2-amino-2-methyl-1-propanol). Then the particles are dispersed in the liquid containing the dispersant. The particles may be dispersed using equipment typically used in the ink, coating, and/or adhesive industries. This equipment is well known to those skilled in the art, and includes, for example, ball mills, stirred bead mills, homogenizers, roll mills, and ultrasonication baths.

The metal oxide particle dispersions may be supplied as a “solution” (i.e., low solids dispersion) or a very high solids (>70%) paste. Typically a relatively high solids paste is useful in applications where the total liquid content of the final coating, such as in ink or adhesive applications, must be minimized.

### INDUSTRIAL APPLICABILITY

The dispersions of the invention contain relatively high levels of particles. The dispersions may be used as master batches in the preparation of, for example, inks, coatings, and adhesives with enhanced mechanical, chemical, electrical, optical or magnetic properties. Because the dispersion is stable, it does not have to be prepared immediately before use. Large amounts can be prepared, which can be stored for future use.

The advantageous properties of this invention can be observed by reference to the following examples, which illustrate certain aspects of the invention and do not limit the scope of the invention or any claims appended hereto.

### EXAMPLES

### Trade Name Chemical Description

Alumina A spherical gamma alumina, BET particle size 15 nm
Alumina B spherical gamma alumina, BET particle size 30 nm
Alumina C spherical 70:30 gamma/delta alumina, BET particle size 47 nm
Alumina D spherical gamma alumina, BET particle size 20 nm
Alumina E spherical gamma alumina, BET particle size 40 nm
Alumina F spherical gamma alumina, BET particle size 15 nm
Alumina G spherical alumina, BET particle size <100 nm
Zirconia A spherical, BET particle size 15 nm
Zirconia B spherical, BET particle size <100 nm
Titania A spherical anatase, BET particle size 17 nm
AMP-95 2-Amino-2-methyl-1-propanol
DHR Salt 2,3-Dihydroxy-6-naphthalene sulfonic acid sodium salt
Tiron Disodium salt monohydrate of 4-5-dihydroxy-1,3 benzenedisulfonic acid

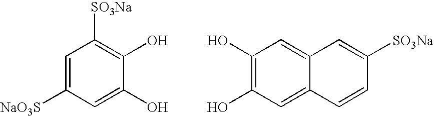

Tego Dispers 752W maleic acid/vinyl polyether copolymer, pH=6
Disperbyk-190 non-ionic copolymer with carboxy anchor groups, pH=7
Zetasperse 1400 acrylate graft copolymer

Examples 1-10 in Table 1 were prepared by dissolving Tiron in the liquid, adding nanoalumina, and sonicating in an ultrasonication bath (Branson Model 3510) at 65 C for the time shown. Physical properties are based upon visual inspection immediately after sonication.

### Viscosity Measurement

The sample were tested using a Brookfiled Model DVII+ at 20 rpm with a #2 spindle. By “fluid” it is meant that the composition or dispersion has a viscosity of less than about 500 cp. By “paste” it is meant the composition is too thick to be poured out of its container.

### Particle Size and Zeta Potential

Samples were diluted to 0.1% solids in the same liquid used to make the dispersion. Particle size and zeta potential were determined using a Malvern Nanosizer (Malvern, Worcestershire, UK) and Malvern Zetasizer® (Malvern, Worcestershire, UK).

Examples 1 and 2 demonstrated that, although nanoalumina can be dispersed in ethylene glycol (EG) at 30% solids, nanoalumina is difficult to disperse at 60% solids.

Examples 3-7 demonstrated that the addition of Tiron yields fluid dispersion up to 60% solids.

Examples 8 and 9 demonstrated that alumina can be dispersed in glycerin at 30% solids with or without Tiron. It was an unexpected result that alumina was dispersed in EG with Tiron at 50% solids (example 6) and that little to no alumina was dispersed in water with Tiron at 50% solids (example 10).

TABLE 1

| | | | Ethylene | | Alumina | Sonicated | Physical |
|---|---|---|---|---|---|---|---|
| Example | Water | Tiron | glycol | Glycerin | ° F. | 65° C., hrs | properties |
| 1 | | | 70 | | 30 | 1 | fluid |
| 2 | | | 40 | | 60 | 3 | paste |
| 3 | | 2 | 68 | | 30 | 1 | fluid |
| 4 | | 2 | 58 | | 40 | 1 | fluid |
| 5 | | 2 | 58 | | 40 | 3 | fluid |
| 6 | | 2 | 48 | | 50 | 1 | fluid |
| 7 | | 2 | 40 | | 60 | 3 | fluid |
| 8 | | 2 | | 68 | 30 | 2 | fluid |
| 9 | | | | 68 | 30 | 2 | fluid |
| 10 | 48 | 2 | | | 50 | 1 | paste |

Composition is dry wt %

The Examples listed in Table 2 were prepared in the same manner as those in Table 1 except that the samples were sonicated 2 hrs at 65 C. Examples 11-30 in Table 2 demonstrate the dispersion of several different alumina samples in different liquids and mixtures of liquids that used either Tiron or DHR salt. Dispersion viscosity, particle size and zeta potential were used to gauge dispersion quality. The commercially available nanopowders typically are comprised of aggregates containing hundreds of thousands of primary nanoparticles. These aggregates are several microns in diameter. The ability to disperse these aggregates into much smaller clusters is a gauge of dispersion efficacy. Similarly, zeta potential can also be used as a measure of dispersion stability. The zeta potential measures the charge on the particle surface. A relatively high negative or positive zeta potential means that the particles will repel each other rather than being attracted and flocculating. Because inks, coatings and adhesives are comprised of anionic ingredients, an anionic nanodispersion is normally effective.

A comparison of Examples 11 and 12 illustrates unexpected results. While surface charge is common for particles dispersed in aqueous media, it is not typically observed in non-aqueous media. Furthermore, the addition of Tiron shifted the charge from a relatively high positive value to an even higher negative value. As described above, an anionic surface charge is typically more suitable for formulating purposes. Example 13 demonstrated that it is difficult to disperse alumina in EG at high solids. Examples 14-19 demonstrated that Tiron was used to disperse different nanoaluminas in EG at up to 60% solids. These dispersions had a relatively low viscosity and a highly negative zeta potential. In Examples 18 and 19, AMP-95 an amine which is typically used in many coating and adhesive formulations, was included in the dispersion without negative impact. Similarly, Examples 20-22 demonstrated that DHR salt can be used to disperse nanoalumina in EG at high solids to achieve a low viscosity, small particle size dispersion with a highly negative zeta potential.

Examples 23-29 demonstrated that Tiron and DHR salt were used to form low viscosity dispersions of nanoalumina at high solids content in polar liquids or mixtures of polar liquids.

TABLE 2
Dispersion of alumina in polar liquids with Tiron and DHR salt

| | | | | | | | | | Viscosity | Particle | Zeta |
|---|---|---|---|---|---|---|---|---|---|---|---|
| | Alumina | DHR | | AMP- | Ethylene | | Propylene | | 20 rpm | size, | potential |
| Ex. | (type) | salt | Tiron | 95 | glycol | Glycerin | glycol | Water | cps | nm | mv |
| 11 | 30 (A) | | | | 70 | | | | fluid | 124 | +55 |
| 12 | 30 (A) | | 2 | | 68 | | | | fluid | 126 | −79 |
| 13 | 60 (A) | | | | 40 | | | | paste | 141 | |
| 14 | 58.3 (A) | | 2.9 | | 38.8 | | | | fluid | 111 | |
| 15 | 40 (A) | | 2 | | 58 | | | | fluid | 116 | |
| 16 | 30 (C) | | 2 | | 68 | | | | fluid | 129 | |
| 17 | 58.8 (C) | | 2 | | 39.4 | | | | fluid | 120 | |
| 18 | 57.4 (C) | | 2.9 | 1.4 | 38.3 | | | | 500 | | |
| 19 | 58.3 (A) | | 1.9 | 1 | 38.8 | | | | 1150 | 130 | −84 |
| 20 | 29.4 (A) | 1.4 | | 0.7 | 68.6 | | | | Fluid | 118 | −87 |
| 21 | 30 (A) | 2 | | 1 | 67 | | | | Fluid | 113 | −76 |
| 22 | 58.3 (A) | 1.9 | | 1 | 37.8 | | | | Fluid | 114 | −82 |
| 23 | 57.7 (B) | 1.9 | | 1.9 | 9.6 | | | 28.8 | 33 | | |
| 24 | 50 (B) | 2 | | 1 | | 50 | | | 530 | | |
| 25 | 49 (B) | | 2 | | 49 | | | | 140 | | |
| 26 | 48.5 (B) | | 1.9 | 1 | 24.3 | 24.3 | | | 535 | | |
| 27 | 48.5 (B) | | 1.9 | 1 | | 24.3 | 24.3 | | 1325 | | |
| 28 | 48.5 (B) | | 1.9 | 1 | 24.3 | | | 24.3 | 108 | | |
| 29 | 48.5 (B) | 1.9 | | 1 | 24.3 | 24.3 | | | 530 | | |

Compositions are in wt %

The Examples in Table 3 were prepared in the same manner as those in Table 2. Table 3 compares Tiron and DHR salt with two structurally similar molecules, 3,4 dihyrdoxybenzoic acid, sodium salt and 4,5-dihydroxynaphthalene-2,7-disulfonic acid, sodium salt. These experiments were performed with 50% nanoalumina, 2% dispersant and 1% AMP-95. The dispersions that were made with Tiron and DHR salt (Ex. 30-33) were relatively low viscosity, small particle size and colorless upon aging at room temperature for one week. The 3,4 dihyrdoxybenzoic acid, sodium salt did not form a dispersion (Ex. 34). The 4,5-dihydroxynaphthalene-2,7-disulfonic acid, sodium salt did form a relatively low viscosity dispersion (Ex. 35) with a small particle size but produced a dark pink color upon aging. The presence of color is normally unacceptable in most applications where nanoparticles would be used, such as inks, coatings, and adhesives.

TABLE 3
Comparison with structurally similar molecules
50% Alumina, 2% dispersant, 1% AMP-95

| | | | | 1 week | |
|---|---|---|---|---|---|
| Exam- | | | 20 rpm | visual | Particle |
| ple | Dispersant | Alumina | viscosity | observation | size, nm |
| 30 | Tiron | B | 157 | Fluid, white | 126 |
| 31 | Tiron | E | 160 | Fluid, white | 141 |
| 32 | Tiron | D | 178 | Fluid, white | 107 |
| 33 | DHR salt | B | 189 | Fluid, white | 133 |
| 34 | 3,4-dihydroxy | B | paste | | 197 |
| | benzoic | | | | |
| | acid, sodium | | | | |
| | salt | | | | |
| 35 | 4,5-dihyrdroxy | B | 277 | Fluid, dark | 127 |
| | naphth.2,7- | | | pink | |
| | disulfonic | | | | |
| | acid, sodium | | | | |
| | salt | | | | |
| 36 | None | B | paste | | 191 |

The Examples in Table 4 were prepared in the same manner as those in Table 2. The Examples in Table 4 demonstrate that Tiron was used effectively to disperse other nanometal oxides in EG.

TABLE 4
Dispersion of other metal oxides

| | | | | | Ethylene | | |
|---|---|---|---|---|---|---|---|
| Example | Titania A | Zirconia A | Alumina G | Zirconia B | glycol | Tiron | Viscosity |
| 37 | 20 | | | | 78 | 2 | Dispersed |
| | | | | | | | well, fluid |
| 38 | | 20 | | | 78 | 2 | Dispersed |
| | | | | | | | well, fluid |
| 39 | | | | 20 | 78 | 2 | Dispersed |
| | | | | | | | well, fluid |
| 40 | | | 30 | | 68 | 2 | Dispersed |
| | | | | | | | well, fluid |

The Examples in Table 5 were prepared in the same manner as those in Table 2. Examples in Table 5 demonstrate that Tiron was also effective in dispersing alumina in propylene glycol to yield dispersions with relatively low viscosity, small particle size and a highly negative zeta potential.

TABLE 5
Dispersions in propylene glycol

| | | | | | Particle | Zeta | Viscosity, |
|---|---|---|---|---|---|---|---|
| | Propylene | | | Alumina | size, | potential, | 20 rpm, |
| Example | glycol | Tiron | AMP-95 | (type) | nm | mv | cps |
| 41 | 48.5 | 2 | 1 | 48.5 (A) | 123 | −46 | 500 |
| 42 | 48.5 | 2 | 1 | 48.5 (B) | 134 | −47 | 305 |

Compositions are in wt %

### Example 43

### Preparation of Dispersion on Three Roll Mill

The following composition was dispersed and milled using a three roll mill (Exakt, Model 80E):

Tiron 4 g

Ethylene glycol 82 g

AMP-95 2 g

Alumina B 121 g

The mixture was passed through the mill three times with a gap opening of 10 microns. The final dispersion was a paste containing 82% nano alumina. This paste was diluted to 40% solids with water. The viscosity of the aqueous dispersion was 92.5 cps. The particle size was 129 nm and the zeta potential was −51.6 my. If desired, the dispersion is substantially free of water during milling and then optionally diluted with water.

Table 6 lists the dielectric constants of a number of different liquids. The dielectric constant is indicative of the polarity of a liquid with more polar liquids having higher values. The dielectric constant is also indicative of the liquids ability to dissolve ionic compounds and maintain charged species in solution. The results in Examples 1-43 indicate that any liquid with a dielectric constant in the range of 35.0-68.1 would be useful in this invention.

TABLE 6
Dielectric Constants of Selected Liquids*

| | Dielectric |
|---|---|
| | constant, |
| Liquid | 25 C |
| N-methylpyrrolidone | 32.0 |
| Methanol | 32.6 |
| propylene glycol | 35.0 |
| dimethylformamide | 36.7 |
| ethylene glycol | 37.0 |
| Acetonitrile | 37.5 |
| Furfural | 41 |
| Glycerin | 42.5 |
| 1:1 water/ethylene glycol | 57.8** |
| 3:1 water/ethylene glycol | 68.1** |
| Water | 78.5 |

*Data obtained from CRC Handbook of Chemistry and Physics
**Value weighted average value calculated from the dielectric constants of neat component

Examples 44-49 were prepared by placing the samples in a sonication bath for 2 hrs at 65 C. Tego Dispers 752W and ZetaSperse 1400 are polymeric dispersants. The results of Examples 44-49 are set forth below in Table 7.

Examples 44-49 show the effect of using different blend ratios of either ZetaSperse 1400 or Tego Dispers 752W with Tiron. As the Tiron level increases from about 0 to about 0.5 to about 1.0 parts, the percentage of particles below about 100 nm typically increases for both the ZetaSperse and Tego blends.

TABLE 7
Dispersion of ITO Nanoparticles in water with Tiron and
Commercial Dispersant

| | | | | Tego | | |
|---|---|---|---|---|---|---|
| | | | | Dispers | ZetaSperse | Particle size, nm |
| Ex. | ITO | Water | Tiron | 752W | 1400 | (% of particles) |
| 44 | 40 | 58 | | | 2 | 98 (22) |
| | | | | | | 269 (78) |
| 45 | 40 | 58 | | 2 | | 95 (32) |
| | | | | | | 219 (68) |
| 46 | 40 | 58 | 0.5 | | 1.5 | 94 (38) |
| | | | | | | 213 (62) |
| 47 | 40 | 58 | 0.5 | 1.5 | | 88 (64) |
| | | | | | | 219 (36) |
| 48 | 40 | 58 | 1 | | 1 | 92 (56) |
| | | | | | | 226 (44) |
| 49 | 40 | 58 | 1 | 1 | | 90 (63) |
| | | | | | | 209 (37) |

Compositions are in wt %

Examples 50-55 were prepared by placing the samples in a sonication bath for 2 hrs at 65 C. Tego Dispers 752W and Disperbyk 190 are polymeric dispersants designed for use in aqueous media.

Examples 52 and 53 show that both 0.5 and 1.0 parts of Disperbyk 190 are less effective, than blends, in stabilizing a dispersion of nanoparticle ZnO in water. A combination of Disperbyk 190 with Tiron (Example 54) yields a stable dispersion with a particle size similar to that which can be achieved with Tiron alone (Examples 50 and 51). Similarly, a combination of Tego Dispers 752W with Tiron (Example 55) yields a stable dispersion with a particle size similar to that which can be achieved with Tiron alone (Examples 50 and 51).

TABLE 8
Dispersion of ZnO Nanoparticles in water with Tiron and
Commercial Dispersant

| | | | | Tego Dispers | Disperbyk | Particle |
|---|---|---|---|---|---|---|
| Ex. | ZnO | Water | Tiron | 752W | 190 | size, nm |
| 50 | 10 | 58 | 0.5 | | | 113 |
| 51 | 10 | 58 | 1 | | | 100 |
| 52 | 10 | 58 | | | 0.5 | Flocculated |
| 53 | 10 | 58 | | | 1 | Flocculated |
| 54 | 10 | 58 | 0.5 | | 0.5 | 121 |
| 55 | 10 | 58 | 0.5 | 0.5 | | 116 |

Compositions are in wt %

Examples 56-59 were prepared by placing the samples in a sonication bath for 2 hrs at 65 C. As illustrated by Examples 56 and 57, Disperbyk 190 and Tego 752W alone did not produce ITO dispersions with greater than 50% of the particles being less than 100 nm. By adding about 0.4% Tiron to a dispersion made with Disperbyk 190 the particle size was reduced from about 340 nm to about 108 nm.

TABLE 9
Dispersion of ITO in water with Tiron and Commercial Dispersant

| | | | | | | Particle |
|---|---|---|---|---|---|---|
| | | | | | Disperbyk | size, nm (% |
| Ex. | ITO | Water | Tiron | Tego 752W | 190 | of particles) |
| 56 | 40 | 58 | | | 2 | 340 (100) |
| 57 | 40 | 58 | | 2 | | 94.4 (32.2) |
| | | | | | | 227 (67.8) |
| 58 | 40 | 58 | 2 | | | 109 (100) |
| 59 | 40 | 57.6 | 0.4 | | 2 | 108 (100) |

Compositions are in wt %

1. A dispersion composition comprising:
a) about 0.1 wt % to about 25 wt %, based on the total weight of the dispersion, of a dispersant comprising at least one ortho-dihydroxy aromatic sulfonic acid salt,
b) about 1 wt % to about 90 wt %, based on the total weight of the dispersion, comprising particles having a particle size of about 1 nm to about 2000 nm; and
c) about 10 wt % to about 90 wt %, based on the total weight of the dispersion, of at least one liquid selected from the group consisting of ethylene glycol, propylene glycol, glycerin, glycol mono-ethers of the formula R″OCH₂CH₂OH, in which R″ is an alkyl group of one to four carbon atoms, and mixtures thereof; in which the particles are dispersed in the liquid; wherein the composition has a negative Zeta potential.

2. The composition of claim 1 in which the dispersant comprises disodium salt monohydrate of 4-5-dihydroxy-1,3 benzenedisulfonic acid.

3. The composition of claim 1 in which the liquid comprises at least one member selected from the group consisting of ethylene glycol, propylene glycol, glycerin, and mixtures thereof.

4. The composition of claim 1 in which the particles have a particle size of about 1 nm to about 100 nm.

5. The composition of claim 1 in which the particles comprise at least one member selected from the group consisting of alumina particles, indium tin oxide particles, zirconia particles, titania particles, iron oxide particles, ceria particles, zinc oxide, aluminum metal particles with a surface layer of aluminum oxide, and mixtures thereof.

6. The composition of claim 3 in which the liquid comprises ethylene glycol and water.

7. The composition of claim 1 in which the dispersant further comprises 2,3-dihydroxy-6-naphthalene sulfonic acid sodium salt.

8. The composition of claim 1 in which the particles comprise alumina particles.

9. The composition of claim 1 wherein the liquid comprises propylene glycol.

10. The composition of claim 1 wherein the liquid further comprises at least one amine compound.

11. The composition of claim 1 wherein the liquid has a dielectric constant of about 35.0 to at least about 68.1.

12. (canceled)

13. (canceled)

14. The composition of claim 1 wherein particles comprise at least one member selected from the group consisting of metal oxides, silica, silane coated metal oxides, and metal particles.

15. A dispersion composition comprising:
a) about 10 wt. % to about 90 wt. % water,
b) about 0.1 wt % to about 25 wt %, based on the total weight of the dispersion, of at least one dispersant comprising at least one orthodihydroxyaromatic sulfonic acid salt,
c) about 1 wt % to about 90 wt %, based on the total weight of the dispersion, of particles comprising at least one member selected from the group consisting of metal particles, metal oxide particles, particles having a metal oxide surface, and mixtures thereof, in which the particles have a particle size of about 1 nm to about 2000 nm;
d) about 10 wt % to about 90 wt %, based on the total weight of the dispersion, comprising at least one liquid, selected from the group consisting of water, ethylene glycol, propylene glycol, glycerin, glycol mono-ethers of the formula R″OCH₂CH₂OH, in which R″ is an alkyl group of one to four carbon atoms, and mixtures thereof, and;
e) about 1 wt % to about 99 wt %, based upon the total weight of the dispersion, comprising at least one member selected from the group consisting of emulsion polymers, aqueous polymer dispersions, aqueous polymer colloids, and aqueous polymer solutions.

16. The composition of claim 15 wherein the dispersant further comprises at least one member selected from the group consisting of polyoxyethylenated long-cain amines, polyoxyethylenated alkyphenols, polyoxyethylenated alcohols, polyoxyethylenated carboxylic acids, polyoxyethylenated sorbitol esters, polyoxyethylenated alkanolamides, long-chain carboxylic acid esters, poly(ethylene oxide-co-propylene oxide), and sulfonated, sulfated, phosphated or phosphonated derivatives of the foregoing; polyacrylates, polyesters, polyamides, maleic acid/vinyl polyether copolymer, styrene-maleic acid copolymers, polyurethanes, polyimides, polyethers, polysilicones and amine, alcohol, acid and ester functionalized derivatives of the foregoing.

17. The composition of claim 15 in which the particles comprise at least one member selected from the group consisting of alumina particles, indium tin oxide particles, zirconia particles, titania particles, iron oxide particles, ceria particles, zinc oxide aluminum metal particles with a surface layer of aluminum oxide, and mixtures thereof.

18. The composition of claim 15 wherein at least about 50% of the particles are less than about 100 nm.

19. The composition of claim 17 wherein the particles comprise alumina particles.

20. The composition of claim 15 wherein the amount of dispersant is sufficient to impart electrostatic and steric stabilization.

21. The composition of claim 15 wherein the dispersant comprises a compound having the formula:

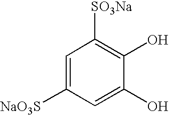

22. The composition of claim 15 wherein the dispersant comprises a compound having the formula:

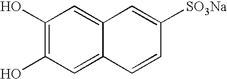

23. The composition of claim 15 wherein the dispersant comprises at least one compound selected from the group of compounds having a formula: 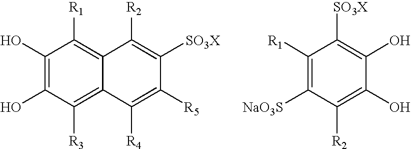
wherein R1-R4 comprise H and/or alkyl, and X comprises at least one member selected from the group consisting of Na, K, Li, NH4, R1NH2, R2NH, and R3N.

24. The composition of claim 15 wherein the polymer comprises at least one of urethane, acrylic, styrene-acrylic, siloxane, vinyl acetate, and vinyl chloride.

25. The composition of claim 19 wherein the liquid comprises ethylene glycol.

26. The composition of claim 25 further comprising 2-amino-2-methyl-1-propanol.

27. The composition of claim 1 wherein the composition has a viscosity of less than about 500 cp.
